(19) United States
(12) Patent Application Publication
(10) Pub. No.: US 2015/0105129 A1
(43) Pub. Date: Apr. 16, 2015

(54) Video Game Body Suit

(71) Applicant: Kevin Chapman, Lucerne Valley, CA (US)

(72) Inventor: Kevin Chapman, Lucerne Valley, CA (US)

(21) Appl. No.: 14/514,478

(22) Filed: Oct. 15, 2014

Related U.S. Application Data
(60) Provisional application No. 61/890,966, filed on Oct. 15, 2013.

(51) Int. Cl. A63F 13/285; A63F 13/212

(52) U.S. Cl. CPC A63F 13/285; A63F 13/212
USPC 463/7

(57) ABSTRACT

A video game body suit for use when playing a video game. The video game body suit includes a torso covering, leg coverings, arm coverings, and a headset. Each of the components includes one or more feedback devices thereon, wherein the feedback device may include one or more of a vibration motor, a speaker, a temperature controlling device, and a scent-emitting device. The headset comprises a headband, an earpiece, and a microphone thereon for allowing the user to remotely communicate with other players. The body suit further includes a control circuit that includes a microprocessor and a transceiver capable of wirelessly communicating with a video game console and the various feedback devices. In this way, the video game body suit can provide feedback to the user corresponding to the events that occur within the game.

### CROSS REFERENCE TO RELATED APPLICATION

This application claims the benefit of U.S. Provisional Application No. 61/890,966 filed on Oct. 15, 2013. The above identified patent application is herein incorporated by reference in its entirety to provide continuity of disclosure.

### BACKGROUND OF THE INVENTION

1. Field of the Invention

The present invention relates to a video game body suit for use when playing a video game. More specifically, the present invention provides a full body suit comprising leg coverings, arm coverings, a torso covering, and a headset, wherein each component includes one or more feedback devices thereon for providing the user with sensory feedback and stimulation corresponding to events that occur in the video game.

Modern video games have become increasingly sophisticated and realistic, as users demand more life-like and immersive gameplay. Video game graphics improve each year and new video game consoles are commonly released with updated hardware. Video games can be played using conventional consoles, on computers, or even on mobile devices. Further, new video games are released throughout the year by any of a variety of game developers, providing user with more and more options of which type and style of video game to play.

Many people who play video games seek an immersive and life-like experience. People may purchase large televisions or displays, surround sound systems, and game controllers with vibrating motors therein in order to increase the sense of realism. However, the user may still desire a more immersive environment that helps to make the user feel as if he or she is part of the gameplay. Thus, a body suit to be worn by a video game player that helps to increase immersion by providing the user with additional sensory stimulation is desired.

The present invention provides a full body suit for use by video game players. The body suit preferably includes a pair of leg coverings, a pair of arm coverings, a torso covering, and a headset. Each component of the body suit includes one or more feedback devices thereon for providing feedback to the user. The feedback devices may include one or more of a vibration motor, a speaker, a temperature controlling device, and a scent-emitting device. The body suit further includes a control circuit comprising a microprocessor and transceiver that is adapted to wirelessly communicate with the video game console or computer on which a video game is played, and also with one or more of the feedback devices. The control circuit is preferably located in the headset of the present invention. The headset further includes an earpiece and a microphone for allowing the user to remotely communicate with other video game players.

2. Description of the Prior Art

Devices have been disclosed in the prior art that relate to video game body suits. These include devices that have been patented and published in patent application publications. These devices generally relate to video game body suits having vibrating motors or other types of devices thereon for stimulating the user in response to gameplay events. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 7,046,151 to Dundon discloses an interactive body suit. The device includes a body suit that covers the user's torso, and further includes gloves and socks. Oscillating motors are embedded in the garment and produce vibrations. A computer graphic that represents the user can be touched in various locations in order to stimulate a response by the body suit in the corresponding location thereon. Thus, while Dundon provides a body suit having vibration means, the body suit is not adapted for use with video games so as to provide the user with an immersive gaming experience. Further, Dundon does not disclose a body suit with various other types of feedback devices including speakers, scent-emitting devices, and the body suit does not include a headset.

U.S. Published Patent Application Number 2005/0113167 to Buchner et al. discloses a physical feedback system for a computer gaming environment. The feedback system comprises a computing device, an interface, and a wearable device having means for receiving signals from the computing device. Thus, while Buchner et al. discloses a wearable garment for use with video games, the garment does not include leg coverings, arm coverings, and a headset.

U.S. Pat. No. 7,967,679 to Ombrellaro et al. discloses a wearable gaming device. The gaming device includes a gaming vest or a similar garment having a pneumatic force generating device therein for applying a force to the user. A compressed air source can be used to actuate the force-generating devices to produce a tactile response. Although Ombrellaro et al. provides a wearable gaming device, the device only utilizes force generators and does not provide other types of feedback devices such as vibration motors, speakers, and scent-emitting devices. Further, Ombrellaro et al. does not disclose other body coverings such as arm coverings, leg coverings, and a headset.

U.S. Published Patent Application Number 2012/0190460 to Sessions discloses a video game console accessory. The accessory comprises a vest with sensory feedback rumblers variously positioned thereon. The rumblers are positioned on the user's torso and the rumblers are independently controlled. Thus, Sessions fails to provide a full body suit comprising leg coverings, arm coverings, a torso covering, and a headset having a variety of feedback devices thereon.

U.S. Pat. No. 7,331,871 to Lopez discloses a vest for use while playing video games. The vest is shaped similarly to a bandoleer and includes tactile signal producing elements thereon. The elements are located variously on the vest so the player will receive signals from all directions. The elements can respond to events that occur during the video game. Thus, Lopez fails to disclose a body suit having leg coverings, arm coverings, and a headset, and instead discloses only a torso covering. Further, Lopez fails to disclose a device having various types of feedback devices.

Finally, U.S. Published Patent Application Number 2011/0183752 to Bey discloses a video game body suit. The body suit includes a plurality of padded hard covers and a video game controller with vibration motors therein. The padded hard covers include vibration motors thereunder. Thus, the body suit of Bey provides only vibration motors and does not disclose other types of feedback devices. Further, Bey fails to provide leg coverings, arm coverings, and a headset in addition to the upper body garment.

These prior art devices have several known drawbacks. Devices in the prior art relate to various garments for producing feedback or stimulation to the user based on events that occur in a video game. However, such devices fail to disclose a full body suit having feedback devices on leg coverings, arm coverings, a torso covering, and a headset. Further, many devices are limited to vibrating motors and do not further include speakers, scent-emitting devices, or temperature controlling devices. Therefore, the devices in the prior art do not provide the user with an immersive experience that enhances the sense of realism experienced by the person playing the game.

In light of the devices disclosed in the prior art, it is submitted that the present invention substantially diverges in design elements from the prior art and consequently it is clear that there is a need in the art for an improvement to existing video game body suit devices. In this regard the instant invention substantially fulfills these needs.

### SUMMARY OF THE INVENTION

In view of the foregoing disadvantages inherent in the known types of video game body suits now present in the prior art, the present invention provides a new video game body suit wherein the same can be utilized for providing convenience for the user when enhancing the sense of immersion and realism while playing a video game.

It is therefore an object of the present invention to provide a new and improved video game body suit device that has all of the advantages of the prior art and none of the disadvantages.

It is another object of the present invention to provide a video game body suit that enhances the user's sense of immersion in a video game by providing various feedback and stimulation to the user's body.

Another object of the present invention is to provide a video game body suit having a plurality of feedback devices located on leg coverings, arm coverings, a torso covering, and a headset.

Yet another object of the present invention is to provide a video game body suit having a variety of feedback devices including vibration motors, speakers, temperature controlling devices, and scent-emitting devices.

A further object of the present invention is to provide a video game body suit that includes a headset comprising a headband, an earpiece, and a microphone that allows the user to communicate remotely with other gamers.

Another object of the present invention is to provide a video game body suit that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a frontal view of an embodiment of the video game body suit of the present invention.

FIG. 2 shows a frontal view of an embodiment of the video game body suit of the present invention as worn by a user.

FIG. 3 shows a close-up view of the headset of the present invention.

FIG. 4 shows a diagram of the operation of the video game body suit of the present invention.

### DETAILED DESCRIPTION OF THE INVENTION

Reference is made herein to the attached drawings. Like reference numerals are used throughout the drawings to depict like or similar elements of the video game body suit. For the purposes of presenting a brief and clear description of the present invention, the preferred embodiment will be discussed as used for enhancing a user's sense of immersion while playing a video game by providing additional sensory feedback to the user. The figures are intended for representative purposes only and should not be considered to be limiting in any respect.

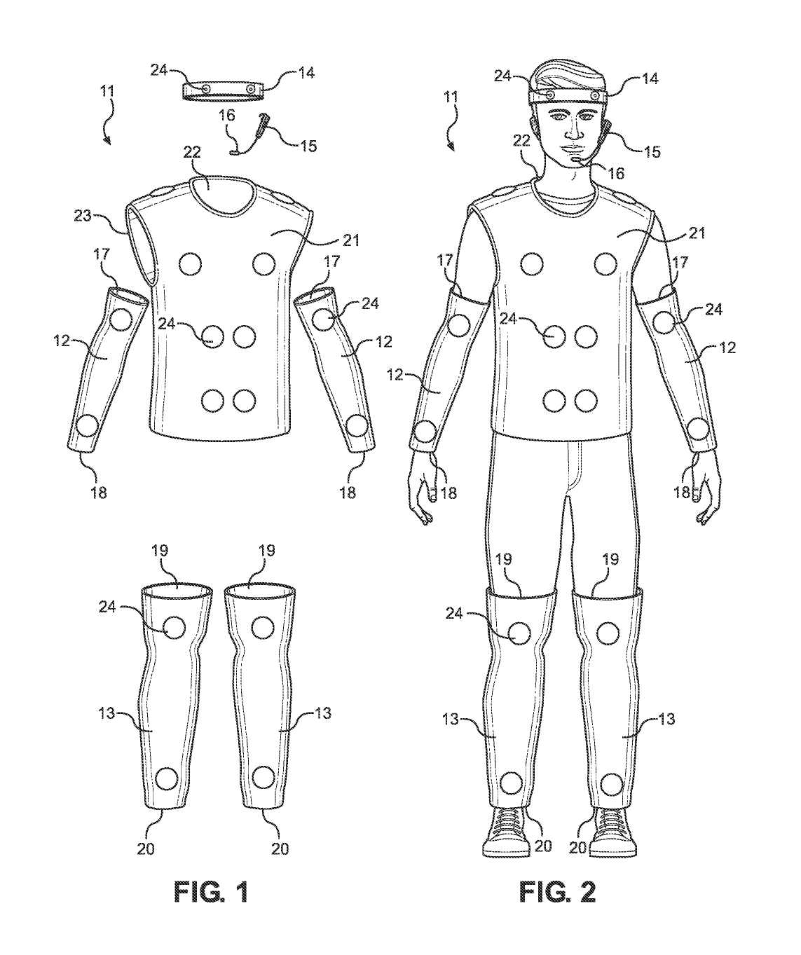

Referring now to FIGS. 1 and 2, there is shown a frontal view of an embodiment of the video game body suit of the present invention, and a view of the present invention as worn by a user. The video game body suit 11 of the present invention comprises one or more garments to be worn by a user. The garments include a pair of leg coverings 13, a pair of arm coverings 12, a torso covering 21, and a headset 14. Each garment includes one or more feedback devices 24 thereon, wherein the feedback devices 24 include at least one of a vibrating motor, a speaker, a scent-emitting device, and a temperature controlling device. Further, each garment may include a power source, such as a battery, for powering the feedback devices 24 thereon.

The various garments are composed of a lightweight and stretchable material so that the garments can stretch to fit individuals of all sizes. The garments may also include elastic about the openings thereon for providing a secure fit on the user. Alternatively, the garments may be composed of a fabric material having straps thereon for adjustably securing the garments to the user. The straps may include fasteners thereon such as hook and loop fastening material for securing the garments to the user. The garments may further include various patterns or designs thereon. The garments are adapted to be worn over a user's clothing.

Each leg covering 13 includes an elongated sleeve having an upper end 19 and a lower end 20. The user can insert his or her leg through the opening on the upper end 19 and pull the leg covering 13 over his or her leg so that the lower end is disposed adjacent to the user's ankle. Thus, the leg covering 13 is adapted to extend from the user's ankle, over the user's lower leg, and up onto the user's thigh. Each leg covering 13 is preferably composed of a stretchable material so that the leg covering 13 snugly fits on the user's leg. One or more feedback devices 24 are positioned on the leg covering 13 on the front and back thereof.

Each arm covering 12 includes an elongated sleeve having an upper end 17 and a lower end 18. The user can insert his or her arm through the upper end 17 and pull the arm covering 12 onto the user's forearm such that the lower end 18 is disposed adjacent the user's wrist. Each arm covering 12 is preferably composed of a stretchable material so that the arm covering 12 snugly fits on the user's arm. The arm coverings 12 include one or more feedback devices 24 thereon. The feedback devices 24 are disposed on the front and back of the arm coverings 12.

The torso covering 21 is adapted to cover the front, back, and sides of the user, and includes a neck opening 22, a pair of arm openings 23, and an open lower end. Thus, the torso covering 21 resembles a vest. The torso covering 21 includes feedback devices 24 distributed on the front and back thereof. Further, the torso covering includes feedback devices 24 on the shoulders thereof. In some embodiments, the torso covering 21 may include a vertical opening on the front portion thereof, separating the front portion into a left and right half.

The feedback devices 24 provide additional sensory stimulus to the user to enhance the user's immersion in a game, and to improve the sense of realism of the game. The feedback devices 24 may include one or more of a vibration motor, a speaker, a temperature controlling device, and a scent-emitting device. The vibration motors are adapted to vibrate in response to an in-game event. For example, when a user is playing a football video game, and the user is tackled, the feedback devices 24 on the user's torso covering 21 can vibrate or jolt to simulate the impact of the tackle. Further, when a user is playing a video game in which the user is shot in the leg, the user's leg covering 13 may vibrate to indicate that the user's leg has been hit.

The feedback devices 24 may also include speakers for providing ambient noise or sound effects. If the user is playing a game in which the user is shooting a gun, the speakers on the user's arm covering may produce a sound effect corresponding to the sound of a gun being fired. The use of speakers on the user's body may help to provide a surround sound effect so that the user hears sounds on all sides of the user's body.

The feedback devices 24 may also include temperature controlling devices and scent-emitting devices. The temperature controlling devices are adapted to produce heat or provide a cooling effect to the user to simulate the climate of the game that the user is playing. Thus, the devices may include heating elements such as metal coils that increase in temperature when an electric current is provided thereto. The temperature controlling devices may also include one or more fans for providing a cooling effect to the user's body. The scent-emitting devices may include one or more compartments in which various scented liquids are stored, wherein the device can emit a particular scent stored therein to correspond to an in-game event or location. For example, the scent of grass can be emitted when a user's game character is passing through a grassy field.

Further, in embodiments having various types of feedback devices, the user can select which types of feedback devices are active. For example, the user can select to disable the temperature controlling devices, and to enable only the vibrating motors. Thus, the user can select the type of feedback that the user wishes to experience during gameplay. The headset may incorporate controlling means, such as one or more push-buttons, that allow the user to turn certain feedback devices on and off.

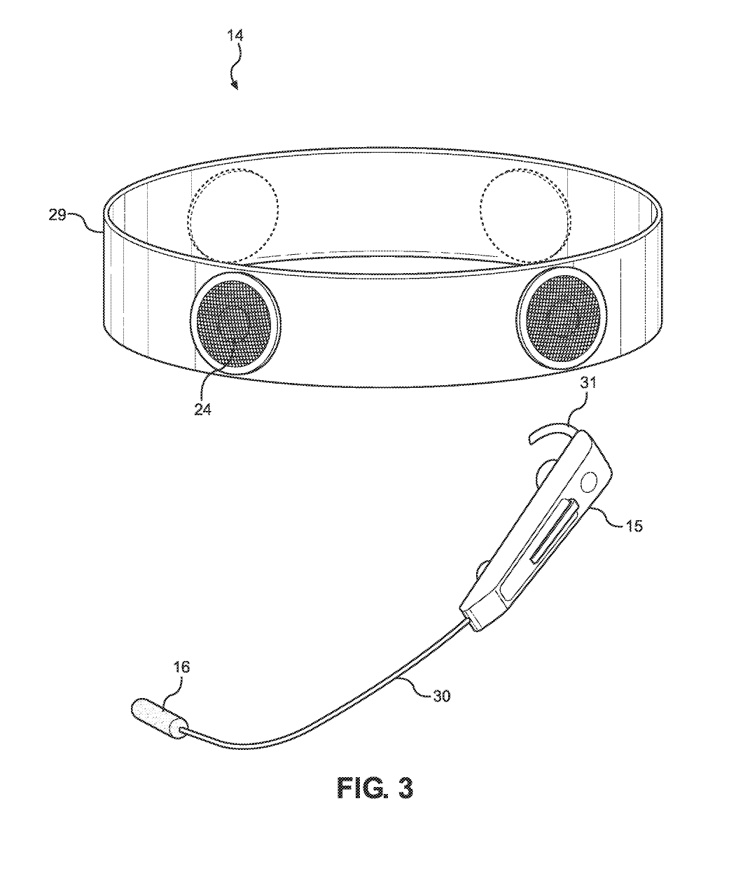

Referring now to FIG. 3, there is shown a close-up view of the headset of the present invention. The present invention further includes a headset 14 comprising a headband 29, an earpiece 15, and a microphone 16. The headset 14 is adapted to allow a user to communicate remotely with other players. The headband 29 includes a stretchable, circular loop that can be worn on the user's forehead. The headband 29 includes one or more feedback devices 24 thereon. Preferably, the feedback devices 24 on the headset 14 include speakers.

The earpiece 15 includes a speaker that can be positioned in a user's ear. The headset 14 includes an ear attachment member 31 for securing the earpiece 15 to the user's ear. The headset 14 further includes a microphone 16 disposed on a flexible rod 30 so that the microphone 16 can be disposed adjacent to the user's mouth. The headset 14 includes a microprocessor and a transceiver that allows the user to wirelessly communicate with the game console and thus with other video game players. In this way, multiple players can communicate remotely while playing a video game.

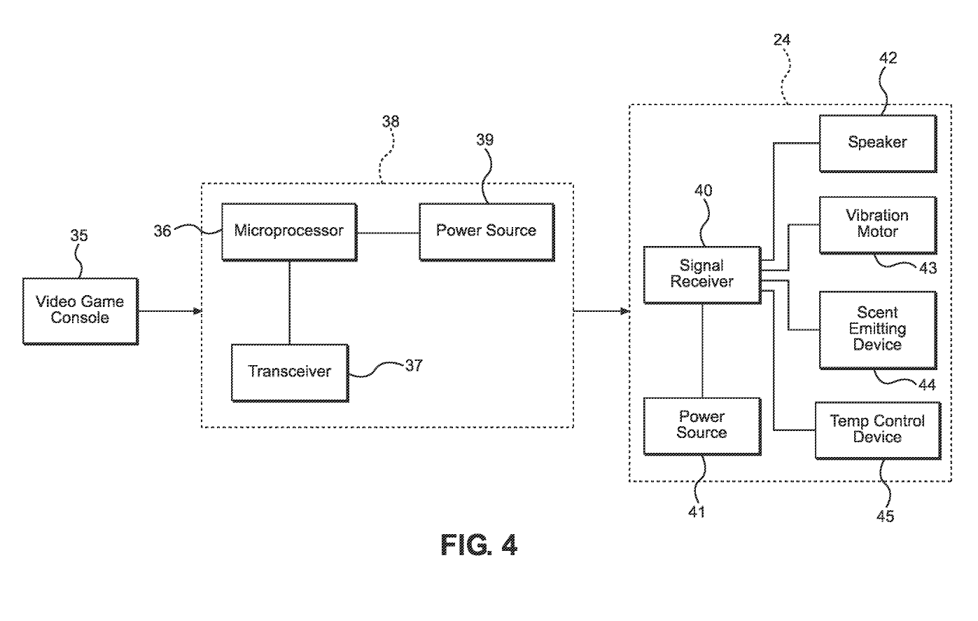

Referring now to FIG. 4, there is shown a diagram of the operation of the video game body suit of the present invention. The video game body suit 11 further comprises a control circuit 38 having a microprocessor 36 and a transceiver 37 that is adapted to communicate with the video game console 35 or computer on which the video game is being played. It is contemplated that the control circuit is powered via a battery or a similar power source 39. The control circuit 38 wirelessly communicates with the various feedback devices 24 on the different portions of the body suit 11. The feedback devices 24 may include signal receiving devices 40 in order to receive signals from the control circuit 38. The feedback devices 24 may include one or more of a speaker 42, a vibration motor, 43, a scent-emitting device 44, and a temperature controlling device 45. Each feedback device 24 may include its own power source 41, or the one or more feedback devices 24 on a garment of the present invention may share a power source 41.

Thus, as an event occurs during gameplay, one or more signals are wirelessly transmitted by the game console 35 to the control circuit 38 in the body suit. In response, the microprocessor 36 and transceiver wirelessly send signals to one or more of the feedback devices 24 to provide the user with stimulus to simulate the in-game event. Feedback devices 24 can be independently signaled so that only one of the several feedback devices 24 is activated. For example, the control circuit 38 may send a signal so as to only activate the feedback devices 24 in the leg coverings of the video game body suit, or so that only one feedback device on a leg covering is activated. Thus, the body suit is adapted to respond to in-game events so as to increase the user's sense of immersion in the video game. The control circuit 38 can be integrated into the headset 14 or torso covering 21 of the video game body suit 11.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A video game body suit, comprising:
a torso covering adapted to cover the front and back of a user;
one or more feedback devices positioned on said torso covering;
each of said one or more feedback devices adapted to provide stimulus to said user corresponding to events in a video game;
a control circuit comprising a microprocessor and a wireless transceiver, wherein said control circuit is adapted to receive signals from a video game console and transmit signals to any of said one or more feedback devices.

2. The video game body suit of claim 1, further comprising a pair of leg coverings; wherein at least one of said one or more feedback devices is disposed on said pair of leg coverings.

3. The video game body suit of claim 2, wherein said pair of leg coverings comprise an elongated sleeve.

4. The video game body suit of claim 2, wherein said pair of leg coverings is composed of a stretchable fabric material.

5. The video game body suit of claim 1, further comprising a pair of arm coverings; wherein at least one of said one or more feedback devices are disposed on said pair of arm coverings.

6. The video game body suit of claim 1, further comprising a headset, wherein said headset comprises a headband, an earpiece having a speaker, and a microphone; wherein said headset allows a user to remotely communicate with other players.

7. The video game body suit of claim 1, wherein said one or more feedback devices comprise vibration motors.

8. The video game body suit of claim 1, wherein said one or more feedback devices comprise speakers.

9. The video game body suit of claim 1, wherein said one or more feedback devices comprise scent-emitting devices.

10. The video game body suit of claim 1, wherein said one or more feedback devices comprise temperature controlling devices.

11. The video game body suit of claim 10, wherein said temperature controlling devices comprise electrical heating elements adapted to increase in temperature when electrical current is provided thereto.

12. The video game body suit of claim 1, wherein said torso covering comprises a vest.

13. A video game body suit, comprising:
a stretchable garment having a plurality of feedback devices attached thereto;
a headset comprising a control circuit having a microprocessor and a transceiver;
wherein said control circuit is adapted to wirelessly send signals to any of said plurality of feedback devices in order to provide a user with stimulus to simulate an in-game event.

14. The video game body suit of claim 13, wherein said headset further comprises a headband, an earpiece, and a microphone.

15. The video game body suit of claim 13, wherein said garment comprises a vest.

16. The video game body suit of claim 13, wherein said garment comprises a pair of leg coverings.

17. The video game body suit of claim 13, wherein said garment comprises a pair of arm coverings.
